(19) United States
(12) Patent Application Publication
(10) Pub. No.: US 2026/0134653 A1
(43) Pub. Date: May 14, 2026

(54) OBJECT OCCLUSION DETECTION FOR OBJECT-CENTRIC IMAGE EDITING

(71) Applicant: ADOBE INC., SAN JOSE, CA (US)

(72) Inventor: Kevin Gary Smith, Lehi, UT (US)

(21) Appl. No.: 18/946,614

(22) Filed: Nov. 13, 2024

(51) Int. Cl. G06V 10/26; G06T 7/13; G06T 7/50; G06T 11/60; G06V 10/25; G06V 20/70

(52) U.S. Cl. CPC G06V 10/26; G06T 7/13; G06T 7/50; G06T 11/60; G06V 10/25; G06V 20/70

(57) ABSTRACT

A method, apparatus, non-transitory computer readable medium, and system for image processing includes obtaining an input image and disparity information for the input image, where the input image depicts a first object and a second object and the disparity information indicates a depth of pixels in the input image and determining a first set of boundary pixels and a second set of boundary pixel from the input image. The first set of boundary pixels represents a first boundary between the first object and the second object and the second set of boundary pixels represents a second boundary between the first object and the second object that is separated from the first boundary. An occlusion label is generated based on the first set of boundary pixels, the second set of boundary pixels, and the disparity information, wherein the occlusion label indicates an occlusion between first object and the second object.

### BACKGROUND

The following relates generally to image processing, and more specifically to image processing using machine learning. An image can include one or more pixels (picture elements), where each pixel includes a pixel value having an intensity or gray level. An image can include one or more image channels, where each image channel can be represented as a grayscale image and includes an array of pixel values. Both color information and depth information (e.g., information relating to distances of surfaces from a viewpoint) of an image can be included in image channels of the image. In some examples, depth information is used for downstream image processing tasks.

An image can be processed using various machine learning methods. Machine learning is an information processing field in which algorithms or models such as artificial neural networks are trained to make predictive outputs in response to input data without being specifically programmed to do so. For example, a machine learning model can be trained to predict occlusion information using image data.

### SUMMARY

Systems and methods are described for object occlusion detection. Embodiments of the present disclosure include an image generation model configured to generate occlusion label for an object in an input image. The image generation model obtains outline pixels for at least two objects in the input image based on an overlap of bounding boxes of the objects. In some cases, the image generation model generates an occlusion label for the input image based on average disparity values (e.g., depth values or camera distance values) corresponding to overlapping pixels among the outline pixels of the objects. In some cases, the generated occlusion label is used for various processing tasks including image editing.

A method, apparatus, and non-transitory computer readable medium for image processing are described. One or more aspects of the method, apparatus, and non-transitory computer readable medium include obtaining an input image and disparity information for the input image, wherein the input image depicts a first object and a second object, and wherein the disparity information indicates a depth of pixels in the input image; determining a first set of boundary pixels and a second set of boundary pixel from the input image, wherein the first set of boundary pixels represents a first boundary between the first object and the second object, and wherein the second set of boundary pixels represents a second boundary between the first object and the second object that is separated from the first boundary; and generating an occlusion label based on the first set of boundary pixels, the second set of boundary pixels, and the disparity information, wherein the occlusion label indicates an occlusion between first object and the second object.

An apparatus and system for image processing are described. One or more aspects of the apparatus and system include a memory component; a processing device coupled to the memory component, the processing device configured to perform operations comprising: obtaining an input image depicting a first object and a second object; determining that the first object overlaps the second object; determining a first set of boundary pixels between the first object and the second object and a second set of boundary pixels between the first object and the second object; and generating an occlusion label based on the first set of boundary pixels and the second set of boundary pixels, wherein the occlusion label indicates an occlusion between the first object and the second object.

### BRIEF DESCRIPTION OF THE DRAWINGS

FIG. 1 shows an example of an image processing system according to aspects of the present disclosure.

FIG. 2 shows an example of a method for generating an image according to aspects of the present disclosure.

FIG. 3 shows an example of a process of identifying occlusion information according to aspects of the present disclosure.

FIG. 4 shows an example of a latent diffusion model according to aspects of the present disclosure.

FIG. 5 shows an example of a U-net architecture according to aspects of the present disclosure.

FIG. 6 shows an example of a diffusion denoising process according to aspects of the present disclosure.

FIG. 7 shows an example of a method for image processing according to aspects of the present disclosure.

FIG. 8 shows an example of a process for generating occlusion information according to aspects of the present disclosure.

FIG. 9 shows an example of a method of training a machine learning model according to aspects of the present disclosure.

FIG. 10 shows an example of a method of training a diffusion model according to aspects of the present disclosure.

FIG. 11 shows an example of a computing device according to aspects of the present disclosure.

FIG. 12 shows an example of an image processing apparatus according to aspects of the present disclosure.

FIG. 13 shows an example of an image generation model according to aspects of the present disclosure.

### DETAILED DESCRIPTION

An image can include one or more pixels (picture elements), where each pixel includes a pixel value having an intensity or gray level. An image can include one or more image channels, where each image channel can be represented as a grayscale image and includes an array of pixel values. Both color information and depth information (e.g., information relating to distances of surfaces from a viewpoint) of an image can be included in image channels of the image.

The color information and depth information (such as a depth map) for an image can be generated using a machine learning model. When the color information and the depth information are generated with each other, the machine learning model causes the color information and the depth information to describe a same scene and be spatially pixel-aligned with each other.

Additionally, for example, the machine learning model provides for a user to modify an image (e.g., delete or move an object in an image) using a click of a mouse, making it easier for a layperson to perform complex image editing tasks. However, in case of computer vision, an occluded object presents a challenge for object detection and recognition algorithms, as only part of the object's features or shape may be visible.

Existing machine learning systems are unable to complete a foreground object that has been occluded by a deleted object. For example, considering an input image that includes a first object occluded by a second object, existing machine learning systems are not able to complete the first object when the second object is deleted. Further, for example, existing machine learning systems are not able to detect a scene with complex occlusion, such as when at least two objects are occluding each other (i.e., mutual occlusion).

Existing machine learning systems are limited since such models consider only the average disparity value of an object in an image. For example, such systems compute average disparity values for each object to identify occluded objects (such as identifying an object that occludes another object). However, an average disparity value (e.g., a single disparity value) is not accurate for a large object, especially when one object is placed on another object.

For example, an average disparity value is not accurate for a large object such as a rug which extends from a foreground region to a background region of an image. In such a case, the average disparity value may be higher for the rug than for a chair placed on the rug. In some cases, the higher disparity value indicates that the rug is occluding the chair which is inaccurate (as the chair being placed on the rug, occludes the rug). As a result, none of the existing machine learning systems are able to accurately and automatically detect occlusion of objects in an image.

By contrast, embodiments of the present disclosure are able to complete an occluded object when a user moves or deletes a foreground object. In some cases, an image generation model of the present disclosure is configured to generate occlusion information for an object in an input image. In some cases, the image generation model generates bounding boxes for the objects in the input image. For example, the image generation model evaluates if the bounding boxes of the objects overlap. In some examples, the image generation model obtains an outline pixel corresponding to each of the overlapping objects.

According to an embodiment, the image generation model identifies overlapping outline pixels associated with the objects and separates the overlapping pixels into contiguous groups. In some cases, an average disparity value of the pixels of an object in each of the corresponding groups is compared to determine the occlusion information. For example, in case the average disparity value computed for an object is larger than the average disparity value computed for another object in the contiguous group, the object is considered as occluding the other object.

Accordingly, by providing the image generation model that can automatically and accurately detect an object that is occluding another object in an image, embodiments of the present disclosure are able to detect occlusion between complex objects. For example, the image generation model is able to accurately detect occlusion when at least two objects in an image are supporting each other or detect occlusion for an object with a broad range of disparity values (such as when at least one object extends from the foreground region to the background region of the image). By accurately detecting the occlusion information associated with an input image, embodiments enable generation of a modified image that accurately inpaints missing pixels of the input image.

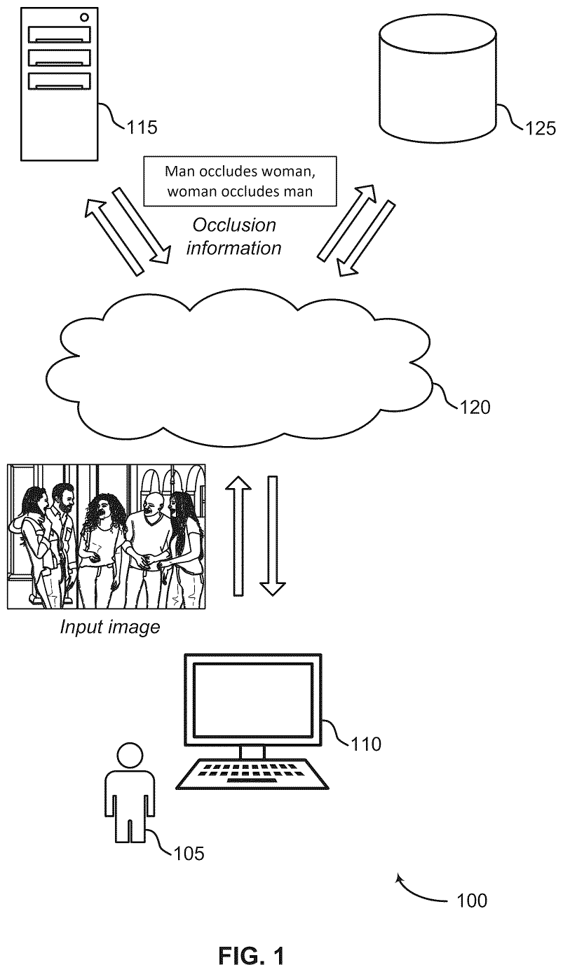

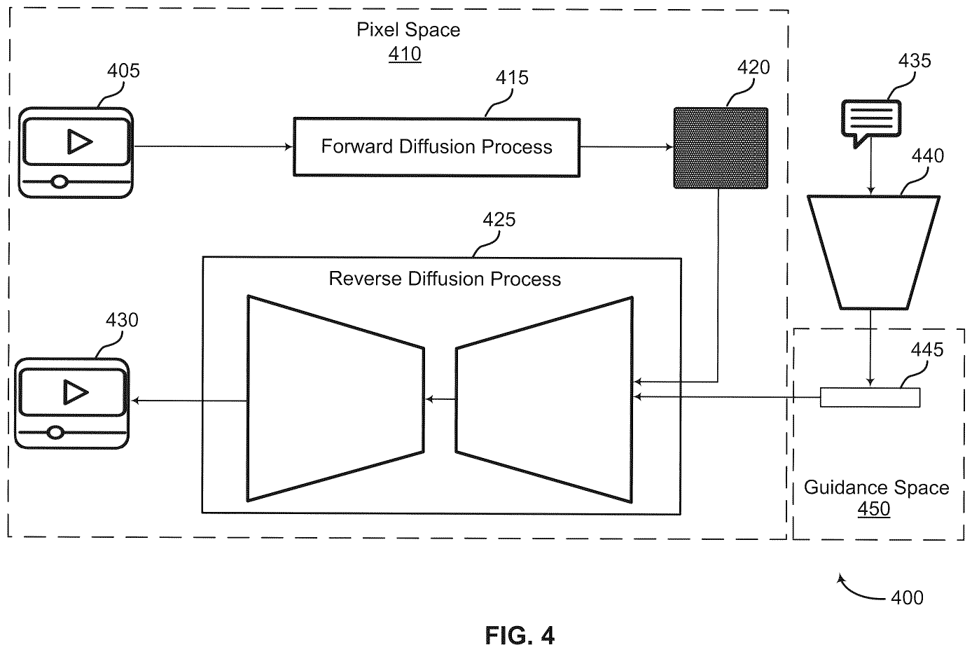

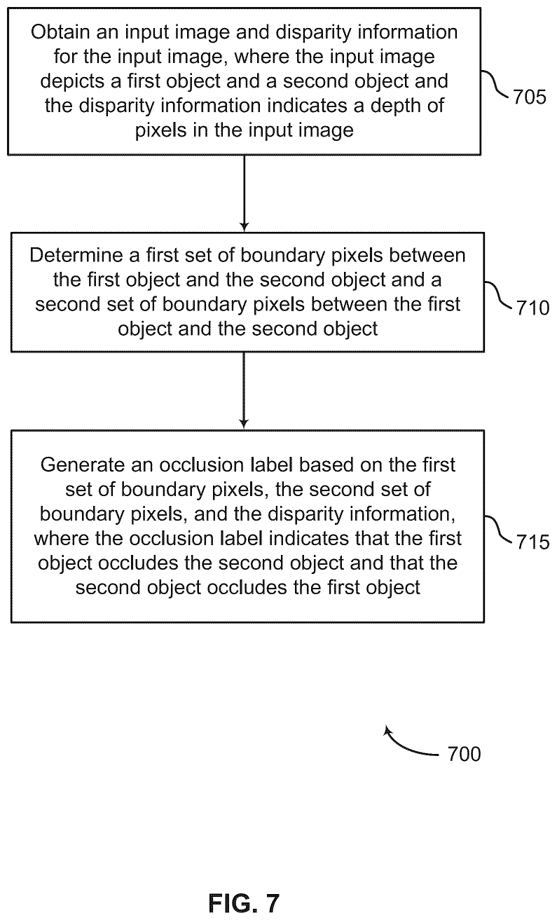

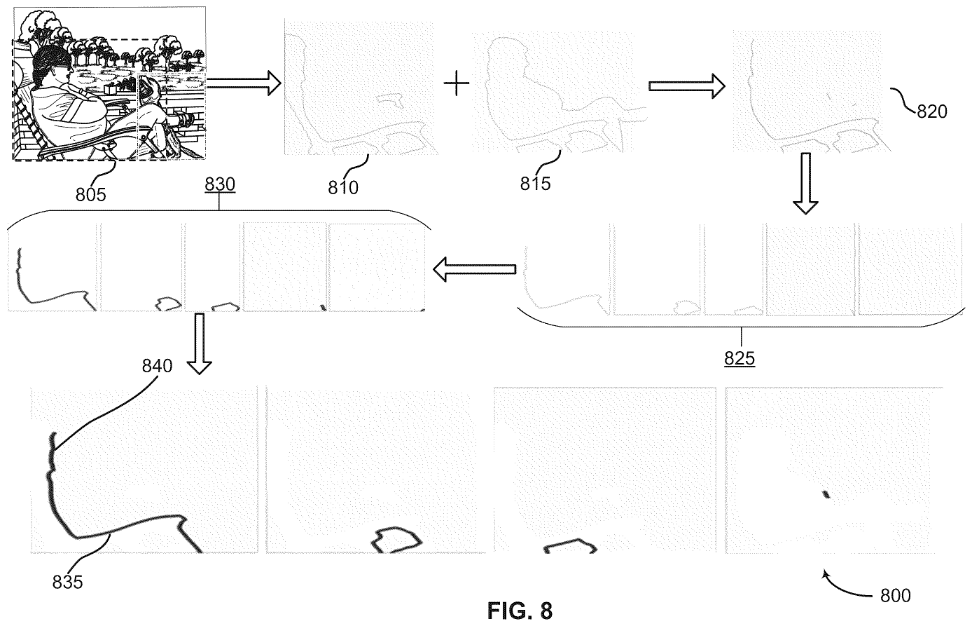

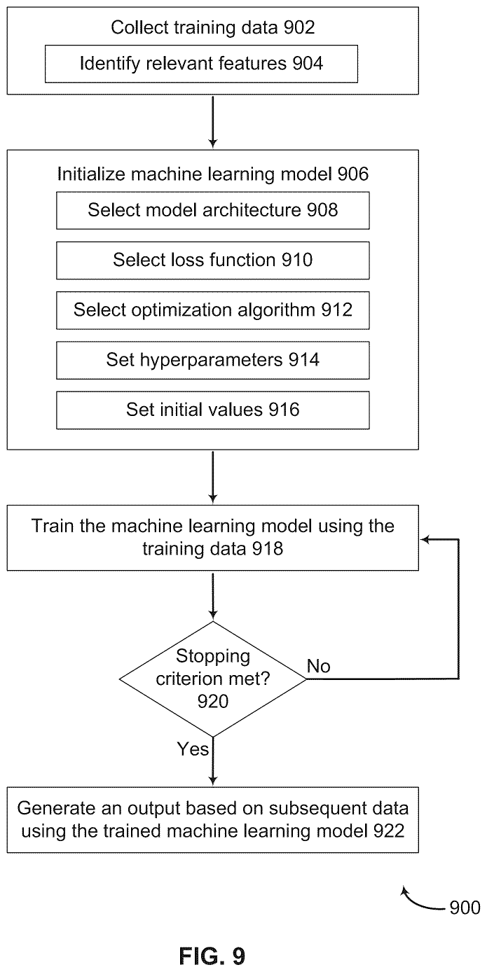

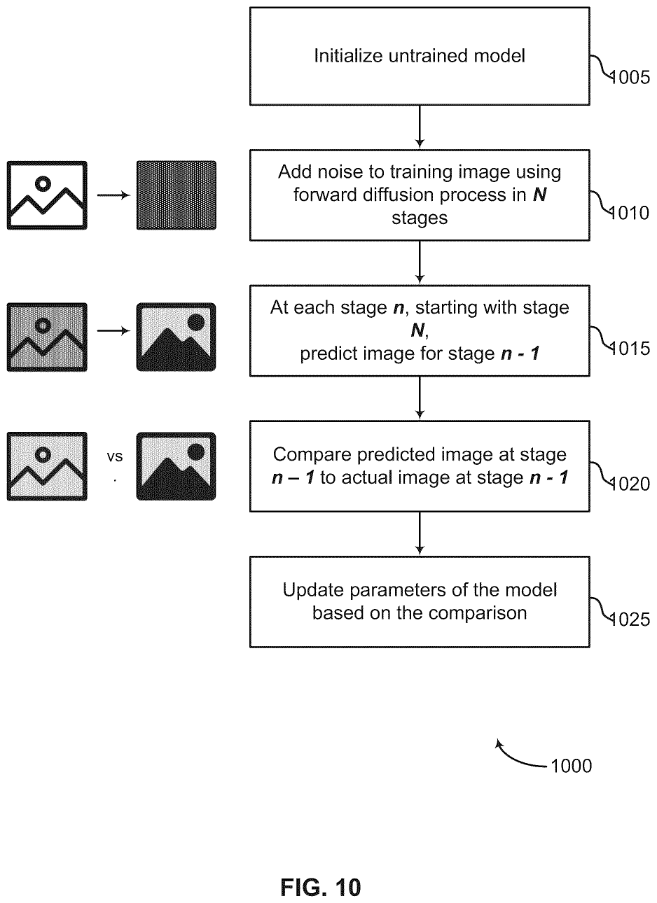

Embodiments of the present disclosure can be implemented in an image generation model. For example, the image generation model based on the present disclosure takes an input image (e.g., detecting a scene) and accurately generates occlusion information that correctly identifies an object that occludes another object in the input image. Example applications regarding generating an occlusion information are provided with reference to FIGS. 1-3. Details regarding the architecture of the image generation model are provided with reference to FIGS. 4-6 and 11-13. Details regarding a process of operation of the image generation model are provided with reference to FIGS. 7-8. Examples of a process for training the image generation model are provided with reference to FIGS. 9-10.

### Image Processing System

A system and an apparatus for image processing are described with reference to FIGS. 1-6. FIG. 1 shows an example of an image processing system 100 according to aspects of the present disclosure. In one aspect, an image processing system 100 includes user 105, user device 110, image processing apparatus 115, cloud 120, and database 125.

In the example of FIG. 1, user 105 provides an input image to image processing apparatus 115 via a user interface provided on user device 110 by image processing apparatus 115. In some cases, the input prompt is an input text. As used herein, the input image depicts a plurality of occluding objects that the user wants to express in a generated occlusion information. As an example shown in FIG. 1, the user provides an input image that depicts multiple objects (e.g., humans) for which the user wants to generate occlusion information using the image processing apparatus 115 of the present disclosure. According to some aspects, image processing apparatus 115 obtains an input image, i.e., depicting multiple humans occluding each other.

As described herein, “occlusion” refers to a phenomenon where one object partially or completely obstructs the view of another. In some cases, occlusion may result in the hidden object being difficult to see or interpret. For example, an “occluded” object refers to an object with “missing” pixels lacking information caused by occlusion from another object.

Referring to the input image in FIG. 1, the man on the right side of the input image is being partially occluded by the two women on his left side and right side. The man on the left side of the image is partially occluded by the first woman on the left side of the image. Additionally, the first woman on the left side of the image is partially occluded by the man on her left side.

In some cases, the image processing apparatus 115 includes an image generation model (such as the image generation model implemented based on the algorithm described with reference to FIGS. 7-8) to generate occlusion information based on the input image. In some cases, as shown in FIG. 1, the user provides an input image to the image processing apparatus 115 and the user wants to obtain the occlusion label for the image. In some examples, the image processing apparatus generates occlusion information that accurately describes the occluded objects depicted in the input image. For example, as shown in FIG. 1, the image processing apparatus generates occlusion information (i.e., “Man occludes woman, woman occludes man”) as depicted in the input image. Thus, in some cases the occlusion label indicates both that the first object and the second object occlude each other.

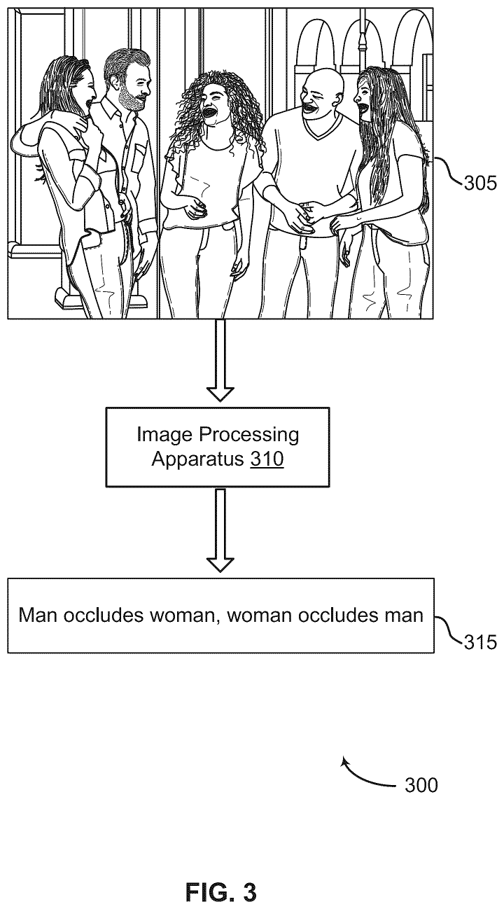

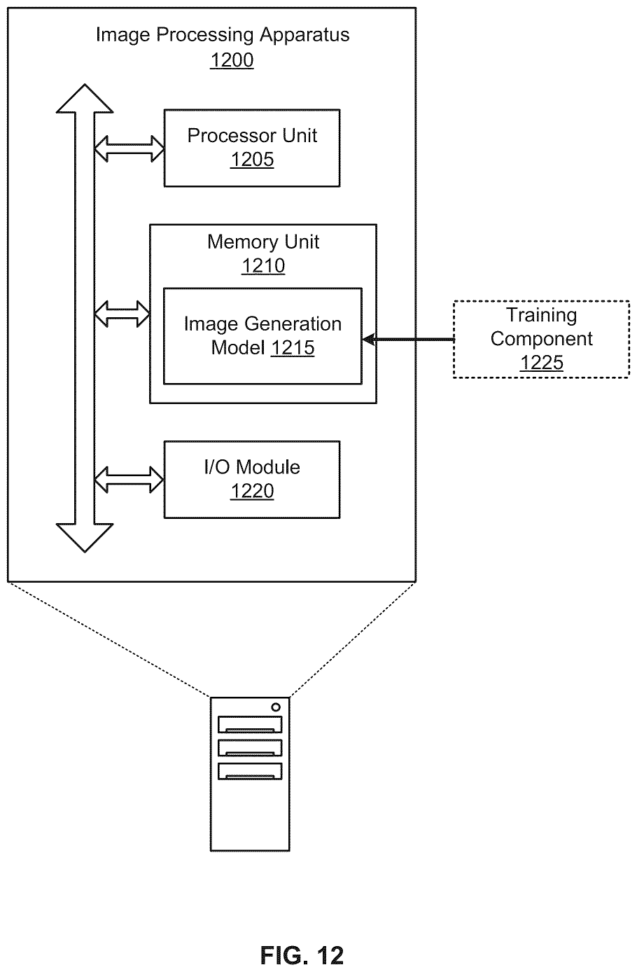

Referring to the example of FIG. 1, the image processing apparatus 115 provides the occlusion information to user 105 via the user interface provided on user device 110. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image processing apparatus 115. In some aspects, the user interface provides for information (such as images (custom images or synthetic image), a prompt, etc.) to be communicated between user 105 and image processing apparatus 115. Image processing apparatus 115 is an example of, or includes aspects of, the corresponding element described with reference to FIGS. 3 and 12.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

According to some aspects, image processing apparatus 115 includes a computer-implemented network. In some embodiments, the computer-implemented network includes a machine learning model (such as the machine learning model described with reference to FIGS. 7 and 8). In some embodiments, image processing apparatus 115 also includes one or more processors, a memory subsystem, a communication interface, an I/O interface, one or more user interface components, and a bus as described with reference to FIG. 12. Additionally, in some embodiments, image processing apparatus 115 communicates with user device 110 and database 125 via cloud 120.

In some cases, image processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, image processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image processing apparatus 115 and communicates with image processing apparatus 115 via cloud 120. According to some aspects, database 125 is included in image processing apparatus 115.

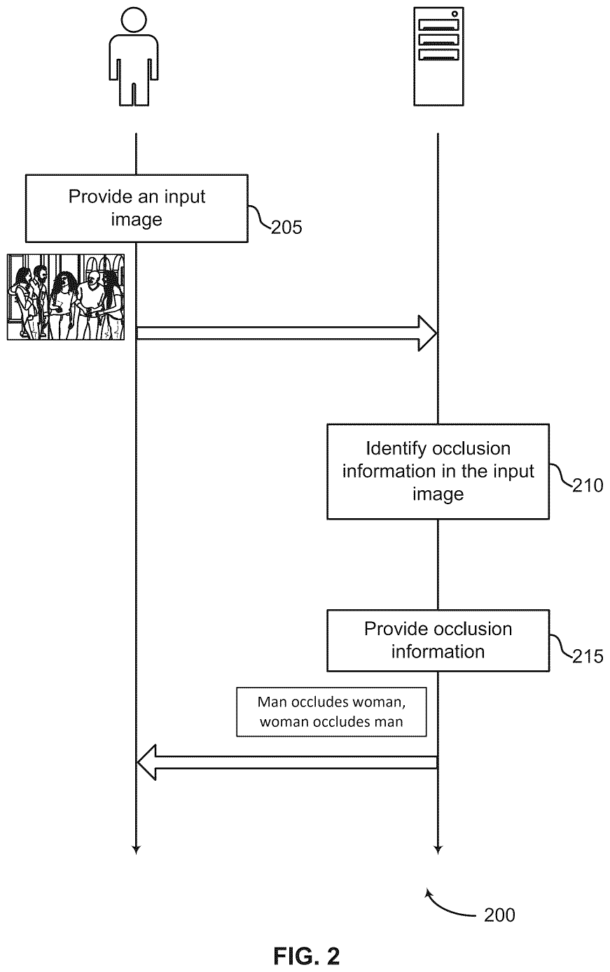

FIG. 2 shows an example of a method 200 a method for generating an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

According to an embodiment of the present disclosure, an image processing apparatus (such as the image processing apparatus described with reference to FIGS. 1, 3, and 12) provides an image generation model (such as the image generation model described with reference to FIGS. 7-8 and 12-13) that accurately generates occlusion information describing aspects of an object depicted in an input image.

At operation 205, the system provides an input image. In some cases, the operations of this step refer to, or may be performed by, a user as described with reference to FIG. 1.

In some examples, the user provides an input image to the image processing apparatus (such as the image processing apparatus described with reference to FIGS. 1, 3, and 12). As shown in FIG. 2, the input image depicts a scene that the user wants to generate occlusion information for. For example, the user wants the occlusion information to describe mutual occlusion (i.e., when two objects occlude each other on the left side of the image) such as the “man occludes woman, and woman occludes man”. In some cases, the user provides the input image to the image processing apparatus via a user interface (such as a graphical user interface) provided on a user device by the image processing apparatus.

At operation 210, the system identifies occlusion information in the input image. In some cases, the operations of this step refer to, or may be performed by, an image processing apparatus as described with reference to FIGS. 1 and 12.

According to an embodiment, the image processing apparatus implements an algorithm (such as the algorithm described with reference to FIGS. 7-8) to identify an object in an image that occludes another object in the image. In some cases, the image processing apparatus identifies overlapping outlines for the objects in the image and then separates the overlapping outlines into contiguous groups. The image processing apparatus is configured to determine occlusion information based on comparing an average disparity value of each pixel in the contiguous group.

According to an embodiment, the disparity value indicates a distance between the camera lens and a pixel of the object. In some cases, the disparity value is computed based on comparing corresponding distances between the object and the camera lens. In some cases, the disparity value is inversely related to the depth of the object. For example, objects closer to the camera lens have higher disparity values and objects distant from the camera lens have lower disparity values.

At operation 215, the system provides the occlusion information. In some cases, the operations of this step refer to, or may be performed by, an image processing apparatus as described with reference to FIGS. 1 and 12.

As shown in FIG. 2, the occlusion information accurately indicates mutual occlusion of the man and woman on the left side of the image. For example, the occlusion information states that the “man occludes woman, woman occludes man”. Referring to the input image received at operation 205, the man partially occludes the woman in the upper region of the image and the woman partially occludes the man (since the woman in the image is standing before the man as perceived via the camera lens). For example, in some cases, the image processing apparatus displays the occlusion information to the user via the user interface (such as the user interface described with reference to FIG. 1).

Accordingly, some embodiments include obtaining an input image depicting a first object and a second object; determining that the first object overlaps the second object; determining a first set of boundary pixels between the first object and the second object and a second set of boundary pixels between the first object and the second object; and generating an occlusion label based on the first set of boundary pixels and the second set of boundary pixels, wherein the occlusion label indicates that the first object occludes the second object and that the second object occludes the first object

FIG. 3 shows an example of a process of identifying occlusion information 300 according to aspects of the present disclosure. In one aspect, process of identifying occlusion information 300 includes input image 305, image processing apparatus 310, and occlusion label 315.

Referring to FIG. 3, input image 305 describes a scene with a plurality of elements (e.g., humans). In some cases, input image 305 depicts a plurality of objects. In some cases, input image 305 depicts mutually occluded objects, i.e., objects that are occluding (e.g., blocking/hiding) each other, e.g., the man and woman on the left side of the image. Input image 305 is an example of, or includes aspects of, the corresponding element described with reference to FIG. 8.

As described herein, input image 305 depicts occlusion of the man on the right side of the image. For example, in case the man on the right side of the image is deleted, the other humans in the image will not be affected since the man on the right side does not occlude any other elements. Additionally, in case either the woman on the right side or the woman in the center of the image is deleted, the man on the right side of the image is to be completed as the man is being partially occluded or obscured by both the women.

As shown in FIG. 3, the image processing apparatus 310 (such as the image processing apparatus described with reference to FIGS. 1, 2, and 12) receives input image 305 from the user. In some cases, the image processing apparatus 310 generates occlusion information that follows aspects of the input image 305. Additionally, in some cases, the image processing apparatus 310 enables modification or editing of input image 305 (e.g., completes objects that are left incomplete due to deletion of another occluding object) based on the occlusion information. For example, the image processing apparatus 310 completes the man on the right side of the image in case the woman in the center is deleted/removed. Similarly, the image processing apparatus 310 completes the man on the left side of the image in case the woman in the left side is deleted/removed.

In some examples, as shown in FIG. 3, the occlusion information generated by the image processing apparatus accurately describes the mutual occlusion of input image 305. That is, the occlusion information correctly describes “man occludes woman, woman occludes man” for the man and woman on the left side of input image 305. Image processing apparatus 310 is an example of, or includes aspects of, the corresponding element described with reference to FIGS. 1 and 12.

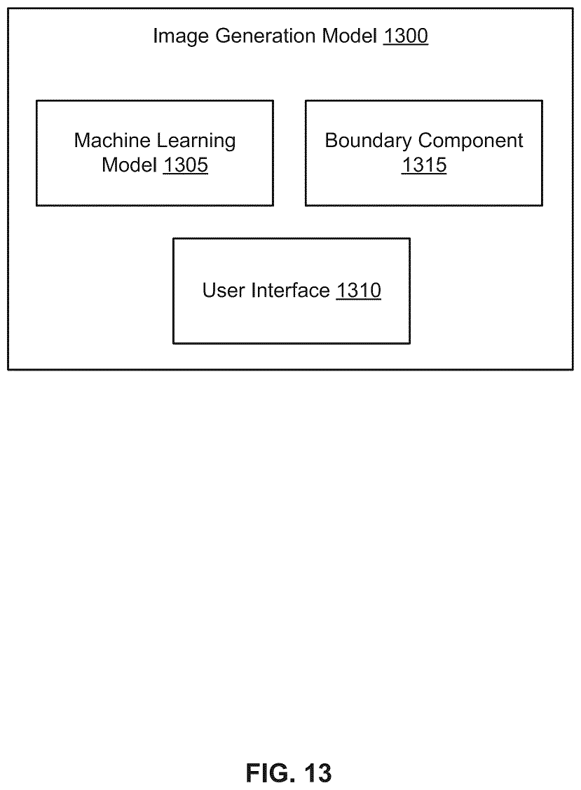

FIG. 4 shows an example of a guided diffusion model 400 according to aspects of the present disclosure. In some examples, guided diffusion model 400 describes the operation and architecture of the image generation model 1215 described with reference to FIG. 12 or image generation model 1300 described with reference to FIG. 13. The guided latent diffusion model 400 depicted in FIG. 4 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 400 may take an original media item 405 in a pixel space 410 as input and apply forward diffusion process 415 to gradually add noise to the original media item 405 to obtain noisy media item 420 at various noise levels.

Next, a reverse diffusion process 425 (e.g., a U-Net) gradually removes the noise from the noisy media item 420 at the various noise levels to obtain an output media item 430. In some cases, an output media item 430 is created from each of the various noise levels. The output media item 430 can be compared to the original media item 405 to train the reverse diffusion process 425.

The reverse diffusion process 425 can also be guided based on a text prompt 435, or another guidance prompt, such as an image, a layout, a segmentation map, etc. The text prompt 435 can be encoded using a text encoder 465 (e.g., a multimodal encoder) to obtain guidance features 445 in guidance space 450. The guidance features 445 can be combined with the noisy media item 420 at one or more layers of the reverse diffusion process 425 to ensure that the output media item 430 includes content described by the text prompt 435. For example, guidance features 445 can be combined with the noisy features using a cross-attention block within the reverse diffusion process 425.

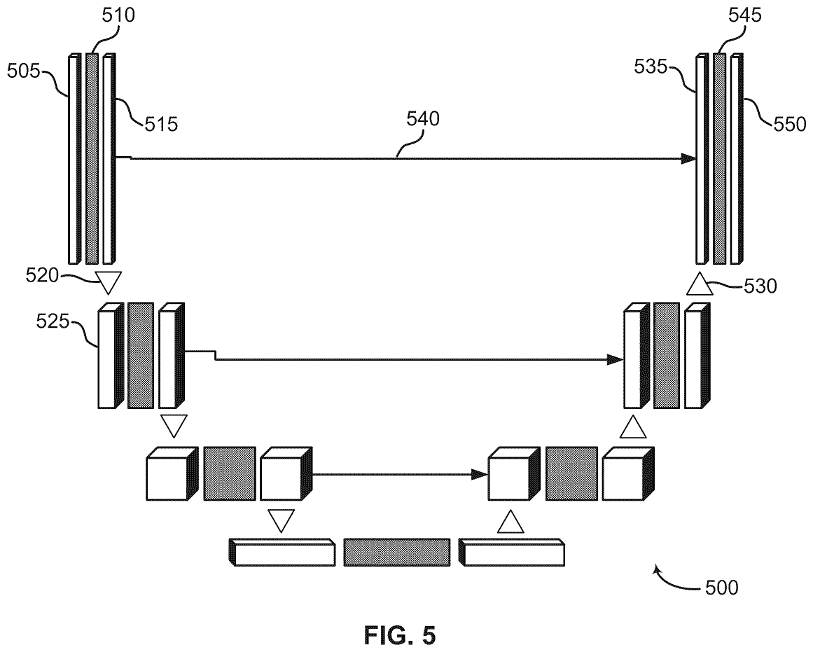

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item. DDIM is an example of, or includes aspects of, the corresponding element described with reference to FIGS. 5-6 and 13.

FIG. 5 shows an example of a U-Net 500 according to aspects of the present disclosure. In some examples, U-Net 500 is an example of the component that performs the reverse diffusion process 425 of guided diffusion model 400 described with reference to FIG. 4 and includes architectural elements of the image generation model 1215 described with reference to FIG. 12 or image generation model 1300 described with reference to FIG. 13. The U-Net 500 depicted in FIG. 5 is an example of, or includes aspects of, the architecture used within the reverse diffusion process described with reference to FIG. 4.

In some examples, diffusion models are based on a neural network architecture known as a U-Net. The U-Net 500 takes input features 505 having an initial resolution and an initial number of channels and processes the input features 505 using an initial neural network layer 510 (e.g., a convolutional network layer) to produce intermediate features 515. The intermediate features 515 are then down-sampled using a down-sampling layer 520 such that down-sampled features 525 features have a resolution less than the initial resolution and a number of channels greater than the initial number of channels.

This process is repeated multiple times, and then the process is reversed. That is, the down-sampled features 525 are up-sampled using up-sampling process 530 to obtain up-sampled features 535. The up-sampled features 535 can be combined with intermediate features 515 having the same resolution and number of channels via a skip connection 540. These inputs are processed using a final neural network layer 545 to produce output features 550. In some cases, the output features 550 have the same resolution as the initial resolution and the same number of channels as the initial number of channels.

In some cases, U-Net 500 takes additional input features to produce conditionally generated output. For example, the additional input features could include a vector representation of an input prompt. The additional input features can be combined with the intermediate features 515 within the neural network at one or more layers. For example, a cross-attention module can be used to combine the additional input features and the intermediate features 515. U-Net architecture is an example of, or includes aspects of, the corresponding element described with reference to FIGS. 2, 4, and 6.

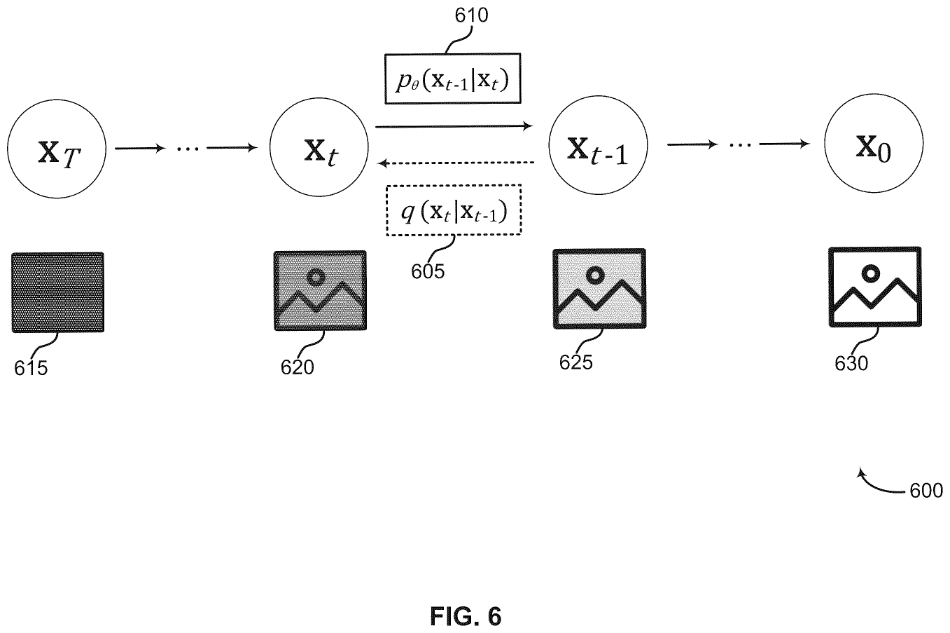

FIG. 6 shows a diffusion process 600 according to aspects of the present disclosure. In some examples, diffusion process 600 describes an operation of the image generation model 1215 described with reference to FIG. 12 or image generation model 1300 described with reference to FIG. 13, such as the reverse diffusion process 425 of guided diffusion model 400 described with reference to FIG. 4.

As described above with reference to FIG. 4, using a diffusion model can involve both a forward diffusion process 605 for adding noise to a media item (or features in a latent space) and a reverse diffusion process 610 for denoising the media item (or features) to obtain a denoised media item. The forward diffusion process 605 can be represented as q(xₜ|xₜ₋₁), and the reverse diffusion process 610 can be represented as p(xₜ₋₁|xₜ). In some cases, the forward diffusion process 605 is used during training to generate media items with successively greater noise, and a neural network is trained to perform the reverse diffusion process 610 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 610, the model begins with noisy data x_{T}, such as a noisy media item 615 and denoises the data to obtain the p(xₜ₋₁|xₜ). At each step t−1, the reverse diffusion process 610 takes xₜ, such as first intermediate media item 620, and t as input. Here, t represents a step in the sequence of transitions associated with different noise levels, The reverse diffusion process 610 outputs xₜ₋₁, such as second intermediate media item 625 iteratively until x_{T} reverts back to x₀, the original media item 630. The reverse process can be represented as:

$${p}_{θ} ( {x}_{t - 1} 1 {x}_{t} ) := N ( {x}_{t - 1} ; {μ}_{θ} ( {x}_{t} , t ) , {\sum }_{θ} ( {x}_{t} , t ) ) \qquad ( 1 )$$

The joint probability of a sequence of samples in the Markov chain can be written as a product of conditionals and the marginal probability:

$${x}_{T} : {p}_{θ} ( {x}_{0 : τ} ) := P ( {x}_{T} ) {\prod }_{t = 1}^{T} θ ( {x}_{t - 1} \vert {x}_{t} ) \qquad ( 2 )$$

where p(x_{T})=N(x_{T}; 0, 1) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and x represents the generated item with high quality. Diffusion process is an example of, or includes aspects of, the corresponding element described with reference to FIGS. 4-5 and 12-13.

Accordingly, an apparatus for image processing is described. One or more aspects of the apparatus include a memory component; a processing device coupled to the memory component, the processing device configured to perform operations comprising: obtaining an input image and disparity information for the input image, wherein the input image depicts a first object and a second object and the disparity information indicates a depth of pixels in the input image; determining a first set of boundary pixels between the first object and the second object and a second set of boundary pixels between the first object and the second object; and generating an occlusion label based on the first set of boundary pixels, the second set of boundary pixels, and the disparity information, wherein the occlusion label indicates that the first object occludes the second object and that the second object occludes the first object.

Some examples of the apparatus and system further include an image generation model configured to generate a modified image based on the input image and the occlusion label.

### Occlusion Label Generation

The present disclosure describes systems and methods for image processing. Embodiments of the present disclosure include an image generation model based on a machine learning model and comprising a boundary component. In some examples, the image generation model receives an input image from a user. For example, the input image depicts a plurality of objects, wherein a first object occludes a second object. Additionally, for example, the input image depicts a plurality of objects, wherein a first object and a second object occlude each other.

The image generation model of the present disclosure is configured to generate occlusion information for an object among a plurality of objects in an input image. In some cases, the image generation model generates bounding boxes for the objects in the input image. For example, the image generation model evaluates if the bounding boxes of the objects overlap. In some examples, the image generation model obtains an outline pixel for the overlapping objects.

According to an embodiment, the image generation model identifies overlapping outline pixels between the objects and separates the overlapping pixels into contiguous groups. In some cases, an average disparity value of the pixels associated with each object for the corresponding contiguous group is compared to determine the occlusion information.

FIG. 7 shows an example of a method 700 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Embodiments of the present disclosure are configured to generate an occlusion label (e.g., an occlusion information). In some cases, an image generation model (such as the image generation model 1215 described with reference to FIG. 12 and the image generation model 1300 described with reference to FIG. 13) of the present disclosure is configured to generate occlusion information that describes aspects of an input image.

For example, the image generation model identifies objects that occlude other objects in an image. Additionally or alternatively, for example, the image generation model identifies objects that are mutually occluded (i.e., objects in an image that occlude each other). Further details regarding generating an occlusion information (or an occlusion label) are provided with reference to at least FIG. 8.

At operation 705, the system obtains an input image and disparity information for the input image, where the input image depicts a first object and a second object and the disparity information indicates a depth of pixels in the input image. In some cases, the operations of this step refer to, or may be performed by, a user interface as described with reference to FIG. 13.

For example, in some cases, the user interface of the image generation model (such as image generation model 1215 described with reference to FIG. 12 or image generation model 1300 described with reference to FIG. 13) receives an input image from a user. In some examples, the image processing apparatus receives the input image from the user or database or any other data source. Additionally, in some examples, the user interface receives disparity information of pixels corresponding to an object in the received image.

At operation 710, the system determines a first set of boundary pixels between the first object and the second object and a second set of boundary pixels between the first object and the second object. In some cases, the operations of this step refer to, or may be performed by, a boundary component as described with reference to FIG. 13.

At operation 715, the system generates an occlusion label based on the first set of boundary pixels, the second set of boundary pixels, and the disparity information, where the occlusion label indicates that the first object occludes the second object and that the second object occludes the first object. In some cases, the operations of this step refer to, or may be performed by, an image generation model as described with reference to FIG. 13.

According to an embodiment of the present disclosure, the image generation model is a machine learning model. In some cases, the image generation model comprises a user interface and a boundary component (such as user interface 1310 and boundary component 1315 described with reference to FIG. 13, respectively). In some cases, the image generation model is configured to generate bounding boxes for each object in an image. For example, the image generation model evaluates an overlap of the bounding boxes.

In case the bounding boxes overlap, the image generation model generates an outline pixel for the objects with overlapping bounding boxes. Next, the image generation model identifies overlapping pixels between the outlines. For example, the image generation model computes an average of a pixel in the outline of a first object and a pixel in the outline of a second object in case a distance between the two pixels is less than a threshold value.

According to an embodiment, the image generation model separates the overlapping outline pixels into contiguous groups. For example, the image generation model generates the distinct contiguous groups based on a distance between the pixels being less than a predetermined threshold value. In some cases, the image generation model expands the outline pixels in each group to include neighboring pixels to generate expanded pixels.

The image generation model compares an average disparity of the expanded pixels of the objects in each group to determine the object that occludes another object. In some cases, the image generation model compares an average disparity of the pixels of the objects in each group to determine mutual occlusion of the objects. The image generation model provides the generated occlusion information to the user via the user interface. Further details regarding generation of the occlusion label are provided with reference to FIG. 8.

FIG. 8 shows an example of occlusion information generation process 800 according to aspects of the present disclosure.

In one aspect, occlusion information generation process 800 includes input image 805, first set of outline pixels 810, second set of outline pixels 815, preliminary set of boundary pixels 820, contiguous pixels 825, expanded boundary pixels 830, first subset 835, and second subset 840.

In some cases, a user interface of the image generation model (such as image generation model 1215 described with reference to FIG. 12 or image generation model 1300 described with reference to FIG. 13) receives an input image 805 from a user. In some examples, the image processing apparatus receives the input image from the user or database or any other data source. Input image 805 is an example of, or includes aspects of, the corresponding element described with reference to FIG. 3.

The image generation model of the present disclosure generates bounding boxes for the objects in input image 805. Referring to FIG. 8, input image 805 includes a first object (e.g., a chair) and a second object (e.g., a woman), wherein the first object and the second object overlap each other.

In some cases, the image generation model obtains a mask outline pixel for each of the objects, i.e., the first object and the second object. For example, the image generation model is configured to iterate through each pixel in the mask and evaluate presence of a neighboring pixel. In some examples, the image generation model evaluates presence of a pixel in the neighboring region (e.g., evaluate presence of another pixel to the left, right, top, and bottom) of the pixel. In case a pixel is not present in any of the said regions, the pixel being evaluated is an outline pixel.

Accordingly, as shown with reference to FIG. 8, the image generation model obtains a first set of outline pixels 810 and a second set of outline pixels 815 corresponding to the first object (e.g., chair) and the second object (e.g., woman), respectively.

In some cases, each pixel in the first set of outline pixels 810 and the second set of outline pixels 815 is evaluated. For example, in case a distance between a pixel in the first set of outline pixels 810 and a pixel in the second set of outline pixels 815 is less than a predetermined threshold value, the said pixels are considered to be overlapping. In some examples, the image generation model computes an average of the said pixels. The image generation model adds (e.g., accumulates) the computed average values to obtain a preliminary set of boundary pixels 820.

For example, referring to FIG. 8, the preliminary set of boundary pixels 820 are divided into five distinct contiguous groups 825. In some examples, the distinct contiguous groups 825 are based on a distance between two pixels. For example, in case the distance between two pixels in the preliminary set of boundary pixels 820 is more than a predetermined threshold (e.g., 10 pixels), the image generation model divides the preliminary set of boundary pixels 820 into a different contiguous group. For example, in case the distance between two pixels in the preliminary set of boundary pixels 820 is less than a predetermined threshold (e.g., 10 pixels), the preliminary set of boundary pixels 820 belong to the same contiguous group.

According to an embodiment, the image generation model of the present disclosure is configured to separate or divide the preliminary set of boundary pixels 820 into a plurality of contiguous groups 825. For example, the image generation model identifies mutual occlusion between objects based on evaluating each region where the first object and the second object overlap (as indicated by the plurality of contiguous groups 825).

According to an embodiment of the present disclosure, the image generation model is configured to expand the pixels in each of the plurality of contiguous groups 825 to generate expanded boundary pixels 830. For example, the image generation model is configured to expand the boundary pixels in the plurality of contiguous groups 825 to include the immediately neighboring pixels according to a configurable threshold. In some cases, the accuracy of disparity estimation is directly proportional to the distance from the boundary/outline pixels.

For example, the disparity estimation is accurate when the pixel is distant (e.g., further away) from the boundary. By expanding the outline pixels in the plurality of contiguous groups 825 to generate expanded boundary pixels 830, embodiments of the present disclosure are able to include pixels from either side of the boundary, i.e., include pixels from each of the first object and the second object. In some cases, the expansion of the boundary is performed to higher degree/extent in the horizontal direction than in the vertical direction since a vertical perspective has an increased influence on the disparity. According to an example, influence on the disparity values is higher in the vertical direction than in the horizontal direction when one object is supporting another object.

Therefore, each group of the plurality of expanded boundary pixels 830 includes pixels from the first object and the second object. In some cases, the image generation model is configured to compute an average of the disparity values of the pixels of the first object and the second object within each group of the plurality of expanded boundary pixels 830.

In case the average disparity value computed for the first object is larger than the average disparity value computed for the second object, the first object is considered as occluding the second object. Thus, the first object occluding the second object indicates the boundary of the first object is closer to the camera lens than the boundary of the second object.

In some cases, the image generation model evaluates each group of the plurality of expanded boundary pixels 830 to detect mutual occlusion of the first and second object. For example, the first subset 835 of boundary pixels corresponds to the first object (e.g., chair) and second subset 840 of boundary pixels corresponds to the second object (e.g., woman). Referring to FIG. 8, in the first three groups, the value of average disparity for the first subset 835 of boundary pixels is more than the value of average disparity for the second subset 840 of boundary pixels.

As a result, the image generation model identifies that the first object (e.g., chair) is occluding the second object (e.g., woman) in each of the first three groups. Further, as shown in FIG. 8, in case of the fourth group, the value of average disparity for the first subset 835 of boundary pixels is less than the value of average disparity for the second subset 840 of boundary pixels. Therefore, the image generation model identifies that the second object (e.g., woman) is occluding the first object (e.g., chair) in the fourth group. Accordingly, considering each of the four groups, the first object and the second object of the input image 805 are mutually occluding, i.e., occluding each other.

Embodiments of the present disclosure include the image generation model that is configured to accurately detect single occlusion and mutual occlusion. Accordingly, a method for image processing is described. One or more aspects of the method include obtaining an input image and disparity information for the input image, wherein the input image depicts a first object and a second object and the disparity information indicates a depth of pixels in the input image; determining a first set of boundary pixels between the first object and the second object and a second set of boundary pixels between the first object and the second object; and generating an occlusion label based on the first set of boundary pixels, the second set of boundary pixels, and the disparity information, wherein the occlusion label indicates that the first object occludes the second object and that the second object occludes the first object.

Some examples of the method, apparatus, and non-transitory computer readable medium further include determining a first bounding box corresponding to the first object and a second bounding box corresponding to the second object. Some examples further include determining that the first bounding box overlaps the second bounding box.

Some examples of the method, apparatus, and non-transitory computer readable medium further include determining a first set of outline pixels for the first object and a second set of outline pixels for the second object. Some examples further include determining a preliminary set of boundary pixels based on a distance between pixels in the first set of outline pixels and pixels in the second set of outline pixels. Some examples further include dividing the preliminary set of boundary pixels to obtain the first set of boundary pixels and the second set of boundary pixels.

Some examples of the method, apparatus, and non-transitory computer readable medium further include determining that the preliminary set of boundary pixels includes a first set of contiguous pixels corresponding to the first set of boundary pixels and a second set of contiguous pixels corresponding to the second set of boundary pixels and separated from the first set of contiguous pixels by a threshold distance.

Some examples of the method, apparatus, and non-transitory computer readable medium further include expanding the first set of boundary pixels and the second set of boundary pixels to obtain a first set of expanded boundary pixels and a second set of expanded boundary pixels, respectively.

Some examples of the method, apparatus, and non-transitory computer readable medium further include identifying a first subset and a second subset of the first set of boundary pixels, wherein the first subset corresponds to the first object and the second subset corresponds to the second object. Some examples further include computing a first disparity value for the first subset and a second disparity value for the second subset. Some examples further include determining that the first object occludes the second object at the first set of boundary pixels based on the first disparity value and the second disparity value.

Some examples of the method, apparatus, and non-transitory computer readable medium further include receiving an edit command for the input image. Some examples further include generating a modified image based on the input image, the edit command, and the occlusion label.

### Training

FIG. 9 shows an example of a method of training a machine learning model according to aspects of the present disclosure. FIG. 9 is a flow diagram depicting an algorithm as a step-by-step procedure 900 in an example implementation of operations performable for training a machine-learning model. In some embodiments, the procedure 900 describes an operation of the training component 1225 described for configuring the image generation model 1215 as described with reference to FIG. 12. The procedure 900 provides one or more examples of generating training data, use of the training data to train a machine-learning model, and use of the trained machine-learning model to perform a task.

To begin in this example, a machine-learning system collects training data (block 902) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 904) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 906). Initialization of the machine-learning model includes selecting a model architecture (block 908) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 910). The loss function is utilized to measure a difference between an output of the machine-learning model (i.e., predictions) and target values (e.g., as expressed by the training data) to be used to train the machine-learning model. Additionally, an optimization algorithm is selected (912) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 914) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 918) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 920), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 920), the procedure 900 continues training of the machine-learning model using the training data (block 918) in this example.

If the stopping criterion is met (“yes” from decision block 920), the trained machine-learning model is then utilized to generate an output based on subsequent data (block 922). The trained machine-learning model, for instance, is trained to perform a task as described above and therefore once trained is configured to perform that task based on subsequent data received as an input and processed by the machine-learning model. The machine learning model or the image generation model, is an example of, or includes aspects of, the corresponding element described with reference to FIGS. 2, 4-6, 10, and 12-13.

FIG. 10 shows an example of a method of training a diffusion model 1000 according to aspects of the present disclosure. In some embodiments, the method 1000 describes an operation of the training component 1225 described for configuring the image generation model 1215 as described with reference to FIG. 12. The method 1000 represents an example for training a reverse diffusion process as described above with reference to FIGS. 4-5. In some examples, these operations are performed by a system including a processor executing a set of codes to control functional elements of an apparatus, such as the guided diffusion model described in FIG. 4.

Additionally or alternatively, certain processes of method 1000 may be performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 10, according to some aspects, a training component (such as the training component 1225 described with reference to FIG. 12) trains a diffusion model (such as the image generation model described with reference to FIGS. 7-8 and 12-13) to generate an image.

At operation 1005, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1010, the system adds noise to a training image (or an additional training image) using a forward diffusion process (such as the forward diffusion process described with reference to FIG. 4) in N stages. In some cases, the operations of this step refer to, or may be performed by, a training component as described with reference to FIG. 12.

At operation 1015, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1020, the system compares predicted output (or features) at stage n−1 to an actual media item (or features), such as the output at stage n−1 or the original input. For example, given observed data x, the diffusion model may be trained to minimize the variational upper bound of the negative log-likelihood-log pe (x) of the training data.

At operation 1025, the system updates parameters of the model based on the comparison. For example, parameters of a U-Net may be updated using gradient descent. Time-dependent parameters of the Gaussian transitions can also be learned.

### Computing Device

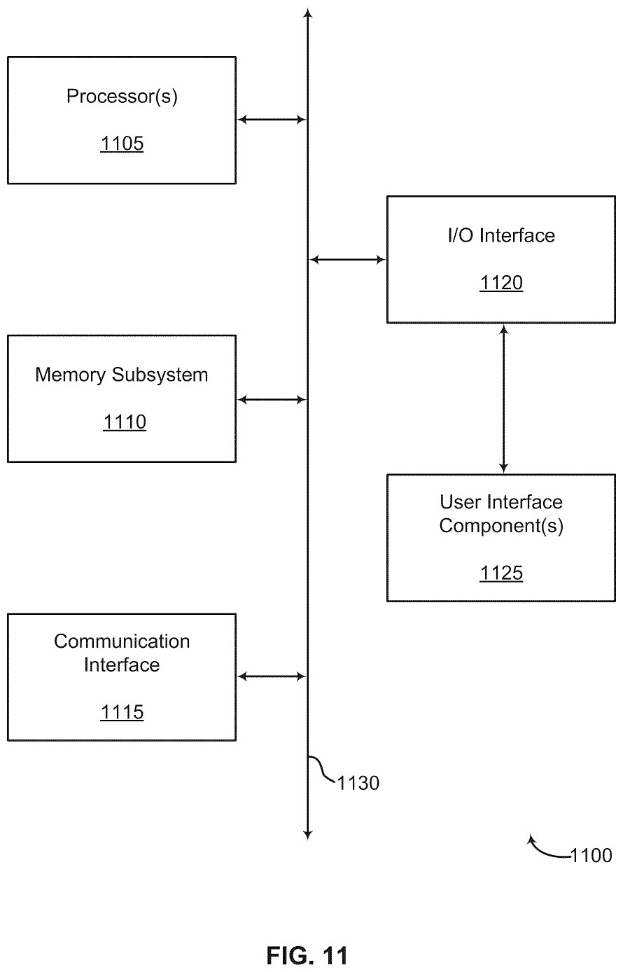

FIG. 11 shows an example of a computing device according to aspects of the present disclosure. The computing device 1100 may be an example of the image processing apparatus 1200 described with reference to FIG. 12. In one aspect, computing device 1100 includes processor(s) 1105, memory subsystem 1110, communication interface 1115, I/O interface 1120, user interface component(s) 1125, and channel 1130.

In some embodiments, computing device 1100 is an example of, or includes aspects of, the image generation model of FIGS. 12-13. In some embodiments, computing device 1100 includes one or more processors 1105 that can execute instructions stored in memory subsystem 1110 to perform media generation.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enable a user to interact with computing device 1100. In some cases, user interface component(s) 1125 include an audio device, such as an external speaker system, an external display device such as a display screen, an input device (e.g., a remote-control device interfaced with a user interface directly or through the I/O controller), or a combination thereof. In some cases, user interface component(s) 1125 include a GUI.

FIG. 12 shows an example of an image processing apparatus 1200 according to aspects of the present disclosure. According to some aspects, image processing apparatus 1200 obtains an input image. In some examples, image processing apparatus 1200 obtains an input prompt. In some embodiments, image processing apparatus 1200 includes processor unit 1205, memory unit 1210, image generation model 1215, I/O module 1220, and training component 1225. Training component 1225 updates parameters of the image generation model 1215 stored in memory unit 1210. In some examples, the training component 1225 is located outside the image processing apparatus 1200.

Processor unit 1205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1205 is configured to operate a memory array using a memory controller. In other cases, a memory controller is integrated into processor unit 1205. In some cases, processor unit 1205 is configured to execute computer-readable instructions stored in memory unit 1210 to perform various functions. In some aspects, processor unit 1205 includes special purpose components for modem processing, baseband processing, digital signal processing, or transmission processing. According to some aspects, processor unit 1205 comprises one or more processors described with reference to FIG. 11.

Memory unit 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1205 to perform various functions described herein.

In some cases, memory unit 1210 includes a basic input/output system (BIOS) that controls basic hardware or software operations, such as an interaction with peripheral components or devices. In some cases, memory unit 1210 includes a memory controller that operates memory cells of memory unit 1210. For example, the memory controller may include a row decoder, column decoder, or both. In some cases, memory cells within memory unit 1210 store information in the form of a logical state. According to some aspects, memory unit 1210 is an example of the memory subsystem 1110 described with reference to FIG. 11.

According to some aspects, image processing apparatus 1200 uses one or more processors of processor unit 1205 to execute instructions stored in memory unit 1210 to perform functions described herein. For example, the image processing apparatus 1200 may obtain an input image and disparity information for the input image, wherein the input image depicts a first object and a second object and the disparity information indicates a depth of pixels in the input image; determine a first set of boundary pixels between the first object and the second object and a second set of boundary pixels between the first object and the second object; and generate an occlusion label based on the first set of boundary pixels, the second set of boundary pixels, and the disparity information, wherein the occlusion label indicates that the first object occludes the second object and that the second object occludes the first object.

The memory unit 1210 may include an image generation model 1215 trained to obtain an input image and disparity information for the input image, wherein the input image depicts a first object and a second object and the disparity information indicates a depth of pixels in the input image; determine a first set of boundary pixels between the first object and the second object and a second set of boundary pixels between the first object and the second object; and generate an occlusion label based on the first set of boundary pixels, the second set of boundary pixels, and the disparity information, wherein the occlusion label indicates that the first object occludes the second object and that the second object occludes the first object. For example, after training, the image generation model 1215 may perform inferencing operations as described with reference to FIGS. 1-3 to obtain an input image and disparity information for the input image, wherein the input image depicts a first object and a second object and the disparity information indicates a depth of pixels in the input image; determine a first set of boundary pixels between the first object and the second object and a second set of boundary pixels between the first object and the second object; and generate an occlusion label based on the first set of boundary pixels, the second set of boundary pixels, and the disparity information, wherein the occlusion label indicates that the first object occludes the second object and that the second object occludes the first object.

In some embodiments, the image generation model 1215 is an Artificial neural network (ANN) such as the guided diffusion model described with reference to FIG. 4 and the U-Net described with reference to FIG. 5. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 1215 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1225 may train the image generation model 1215. For example, parameters of the image generation model 1215 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 9). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 1215 can be used to make predictions on new, unseen data (i.e., during inference).

I/O module 1220 receives inputs from and transmits outputs of the image processing apparatus 1200 to other devices or users. For example, I/O module 1220 receives inputs for the image generation model 1215 and transmits outputs of the image generation model 1215. According to some aspects, I/O module 1220 is an example of the I/O interface 1120 described with reference to FIG. 11.

FIG. 13 shows an example of an image generation model 1300 according to aspects of the present disclosure. Image generation model 1300 is an example of, or includes aspects of, the corresponding element described with reference to FIG. 12. In one aspect, image generation model 1300 includes machine learning model 1305, user interface 1310, and boundary component 1315.

According to some aspects, image generation model 1300 generates an occlusion label based on the first set of boundary pixels, the second set of boundary pixels, and the disparity information, where the occlusion label indicates that the first object occludes the second object and that the second object occludes the first object. In some examples, image generation model 1300 determines that the first bounding box overlaps the second bounding box.

In some examples, image generation model 1300 divides the preliminary set of boundary pixels to obtain the first set of boundary pixels and the second set of boundary pixels. In some examples, image generation model 1300 determines that the preliminary set of boundary pixels includes a first set of contiguous pixels corresponding to the first set of boundary pixels and a second set of contiguous pixels corresponding to the second set of boundary pixels and separated from the first set of contiguous pixels by a threshold distance.

In some examples, image generation model 1300 expands the first set of boundary pixels and the second set of boundary pixels to obtain a first set of expanded boundary pixels and a second set of expanded boundary pixels, respectively. In some examples, image generation model 1300 identifies a first subset and a second subset of the first set of boundary pixels, where the first subset corresponds to the first object and the second subset corresponds to the second object.

In some examples, image generation model 1300 computes a first disparity value for the first subset and a second disparity value for the second subset. In some examples, image generation model 1300 determines that the first object occludes the second object at the first set of boundary pixels based on the first disparity value and the second disparity value. In some examples, image generation model 1300 generates a modified image based on the input image, the edit command, and the occlusion label.

According to some aspects, image generation model 1300 generates an occlusion label based on the first set of boundary pixels, the second set of boundary pixels, and the disparity information, where the occlusion label indicates that the first object occludes the second object and that the second object occludes the first object. In some examples, image generation model 1300 is configured to generate a modified image based on the input image and the occlusion label.

According to some aspects, user interface 1310 obtains an input image and disparity information for the input image, where the input image depicts a first object and a second object and the disparity information indicates a depth of pixels in the input image. In some examples, user interface 1310 receives an edit command for the input image.

According to some aspects, boundary component 1315 determines a first set of boundary pixels between the first object and the second object and a second set of boundary pixels between the first object and the second object. In some examples, boundary component 1315 determines a first bounding box corresponding to the first object and a second bounding box corresponding to the second object. In some examples, boundary component 1315 determines a first set of outline pixels for the first object and a second set of outline pixels for the second object. In some examples, boundary component 1315 determines a preliminary set of boundary pixels based on a distance between pixels in the first set of outline pixels and pixels in the second set of outline pixels.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image processing, comprising:
obtaining an input image and disparity information for the input image, wherein the input image depicts a first object and a second object, and wherein the disparity information indicates a depth of pixels in the input image;
determining a first set of boundary pixels and a second set of boundary pixel from the input image, wherein the first set of boundary pixels represents a first boundary between the first object and the second object, and wherein the second set of boundary pixels represents a second boundary between the first object and the second object that is separated from the first boundary; and
generating an occlusion label based on the first set of boundary pixels, the second set of boundary pixels, and the disparity information, wherein the occlusion label indicates an occlusion between the first object and the second object.

2. The method of claim 1, wherein determining the first set of boundary pixels and the second set of boundary pixels comprises:
determining a first bounding box corresponding to the first object and a second bounding box corresponding to the second object; and
determining that the first bounding box overlaps the second bounding box.

3. The method of claim 1, wherein determining the first set of boundary pixels and the second set of boundary pixels comprises:
determining a first set of outline pixels for the first object and a second set of outline pixels for the second object;
determining a preliminary set of boundary pixels based on a distance between pixels in the first set of outline pixels and pixels in the second set of outline pixels; and
dividing the preliminary set of boundary pixels to obtain the first set of boundary pixels and the second set of boundary pixels.

4. The method of claim 3, wherein dividing the preliminary set of boundary pixels comprises:
determining that the preliminary set of boundary pixels includes a first set of contiguous pixels corresponding to the first set of boundary pixels and a second set of contiguous pixels corresponding to the second set of boundary pixels and separated from the first set of contiguous pixels by a threshold distance.

5. The method of claim 1, further comprising:
expanding the first set of boundary pixels and the second set of boundary pixels to obtain a first set of expanded boundary pixels and a second set of expanded boundary pixels, respectively.

6. The method of claim 1, wherein generating the occlusion label comprises:
identifying a first subset and a second subset of the first set of boundary pixels, wherein the first subset corresponds to the first object and the second subset corresponds to the second object;
computing a first disparity value for the first subset and a second disparity value for the second subset; and
determining that the first object occludes the second object at the first set of boundary pixels based on the first disparity value and the second disparity value.

7. The method of claim 1, wherein:
the occlusion label indicates a mutual occlusion between the first object and the second object.

8. A non-transitory computer readable medium storing code for image processing, the code comprising instructions that, when executed by at least one processor, cause the at least one processor to perform operations comprising:
obtaining an input image depicting a first object and a second object;
determining that the first object overlaps the second object;
determining a first set of boundary pixels between the first object and the second object and a second set of boundary pixels between the first object and the second object; and
generating an occlusion label based on the first set of boundary pixels and the second set of boundary pixels, wherein the occlusion label indicates an occlusion between the first object and the second object.

9. The non-transitory computer readable medium of claim 8, wherein determining the first set of boundary pixels and the second set of boundary pixels comprises:
determining a first bounding box corresponding to the first object and a second bounding box corresponding to the second object; and
determining that the first bounding box overlaps the second bounding box.

10. The non-transitory computer readable medium of claim 8, wherein determining the first set of boundary pixels and the second set of boundary pixels comprises:
determining a first set of outline pixels for the first object and a second set of outline pixels for the second object;
determining a preliminary set of boundary pixels based on a distance between pixels in the first set of outline pixels and pixels in the second set of outline pixels; and
dividing the preliminary set of boundary pixels to obtain the first set of boundary pixels and the second set of boundary pixels.

11. The non-transitory computer readable medium of claim 10, wherein dividing the preliminary set of boundary pixels comprises:
determining that the preliminary set of boundary pixels includes a first set of contiguous pixels corresponding to the first set of boundary pixels and a second set of contiguous pixels corresponding to the second set of boundary pixels and separated from the first set of contiguous pixels by a threshold distance.

12. The non-transitory computer readable medium of claim 8, the code further comprising instructions that, when executed by the at least one processor, cause the at least one processor to perform operations comprising:
expanding the first set of boundary pixels and the second set of boundary pixels to obtain a first set of expanded boundary pixels and a second set of expanded boundary pixels, respectively.

13. The non-transitory computer readable medium of claim 8, wherein generating the occlusion label comprises:
identifying a first subset and a second subset of the first set of boundary pixels, wherein the first subset corresponds to the first object and the second subset corresponds to the second object;
computing a first disparity value for the first subset and a second disparity value for the second subset; and
determining that the first object occludes the second object at the first set of boundary pixels based on the first disparity value and the second disparity value.

14. The non-transitory computer readable medium of claim 8, the code further comprising instructions that, when executed by the at least one processor, cause the at least one processor to perform operations comprising:
obtain disparity information indicating a depth of pixels in the input image, wherein the occlusion label is generated based on the occlusion information.

15. A system comprising:
a memory component; and
a processing device coupled to the memory component, the processing device configured to perform operations comprising:
obtaining an input image and disparity information for the input image, wherein the input image depicts a first object and a second object, and wherein the disparity information indicates a depth of pixels in the input image;
determining a first set of boundary pixels and a second set of boundary pixel from the input image, wherein the first set of boundary pixels represents a first boundary between the first object and the second object, and wherein the second set of boundary pixels represents a second boundary between the first object and the second object that is separated from the first boundary; and
generating an occlusion label based on the first set of boundary pixels, the second set of boundary pixels, and the disparity information, wherein the occlusion label indicates an occlusion between the first object and the second object.

16. The system of claim 15, wherein determining the first set of boundary pixels and the second set of boundary pixels comprises:
determining a first bounding box corresponding to the first object and a second bounding box corresponding to the second object; and
determining that the first bounding box overlaps the second bounding box.

17. The system of claim 15, wherein determining the first set of boundary pixels and the second set of boundary pixels comprises:
determining a first set of outline pixels for the first object and a second set of outline pixels for the second object;
determining a preliminary set of boundary pixels based on a distance between pixels in the first set of outline pixels and pixels in the second set of outline pixels; and
dividing the preliminary set of boundary pixels to obtain the first set of boundary pixels and the second set of boundary pixels.

18. The system of claim 17, wherein dividing the preliminary set of boundary pixels comprises:
determining that the preliminary set of boundary pixels includes a first set of contiguous pixels corresponding to the first set of boundary pixels and a second set of contiguous pixels corresponding to the second set of boundary pixels and separated from the first set of contiguous pixels by a threshold distance.

19. The system of claim 15, wherein generating the occlusion label comprises:
identifying a first subset and a second subset of the first set of boundary pixels, wherein the first subset corresponds to the first object and the second subset corresponds to the second object;
computing a first disparity value for the first subset and a second disparity value for the second subset; and
determining that the first object occludes the second object at the first set of boundary pixels based on the first disparity value and the second disparity value.

20. The system of claim 15, further comprising:
an image generation model configured to generate a modified image based on the input image and the occlusion label.
